(19) United States
(12) Patent Application Publication
(10) Pub. No.: US 2004/0227406 A1
(43) Pub. Date: Nov. 18, 2004

(54) Centralized AC/DC converter for collections of similar servers or other multiple individual electronic units

(76) Inventor: Frank W. Johnson, Beulah, MI (US)

Correspondence Address: Frank W. Johnson, 5785 Van Deman Pl., POB 229, Beuah, MI, 49617, US

(21) Appl. No.: 10/438,626

(22) Filed: May 16, 2003

(51) Int. Cl. H02J 7/34

(52) U.S. Cl. 307/65; 307/18

(57) ABSTRACT

This invention is a system for replacing all of the individual AC/DC power converters of the individual electronic units in the computer room or a separate part of it, by a centralized AC/DC power converter. These converters will have redundancy, back up, controls and systems to monitor and warm of failure or predicted failure. This would be both more effective and less expensive as we would not have to provide any of the AC/DC converters at the individual unit level. Thus you will have better, reliability, redundancy, and fault detection and control at a reduced cost.

### REFERENCES CITED

### US PATENT DOCUMENTS

U.S. Pat. No. 6,523,112 Gallagher, et al, Operating system boot program and execution method

U.S. Pat. No. 6,300,847 Gallagher, et al Backplane having transmission line ethernet bus.

U.S. Pat. No. 6,157,534 Gallagher, et al Backplane having transmission line ethernet bus

U.S. Pat. No. 6,078,503 Gallagher, et al Partionable Cabinet

U.S. Pat. No. 6,023,148 Pignolet, Power management systems with redundant independent replacement battery chargers.

### STATEMENT REGARDING FEDERALLY SUPPORTED RESEARCH OR DEVELOPMENT

There was no federal support in research or development.

This invention is a system for replacing all of the individual AC/DC power converters of the individual electronic units in the computer room or a separate part of it, by a centralized AC/DC power converter. These converters will have redundancy, back up, controls and systems to monitor and warm of failure or predicted failure. This would be both more effective and less expensive as we would not have to provide any of the AC/DC converters at the individual unit level. Thus you will have better, reliability, redundancy, and fault detection and control at a reduced cost.

### BACKGROUND OF THE INVENTION

When PCs, disc drives, servers, and other electronic equipment were first developed, they were largely stand alone equipment. With the expansion of both individual units and the increasing use of multiple near identical units, we now have groups of units.

With this grouping of units, we now have many functions of each unit that can be combined. They can all be in the same room, with temperature, humidity and other variables provided for all of the units. This is clearly more effective than individual rooms such as a PC at home.

All near-identical servers, routers, hard drives, CPUs have functions that can be handled in common. This patent applies to the providing the necessary AC/DC power converters for each electronic unit, from a common source, rather than having an AC/DC converter at each unit.

### PRIOR ART

U.S. Pat. Nos. 6,523,112, 6,300,847, 6,157,534, 6,078,503 are all Gallagher, et all and are assigned to EMC Corporation, as is U.S. Pat. No. 6,023,148, Pignolet. They form a group of EMC patents that describes a cabinet holding “a data server having a plurality of hot replaceable unit modules”. Theses patents are the nearest prior art, in that they have separated the AC/DC power converters from the individual unit, and combined them in one or two units. However these central DC converters supply only +48 volts. The individual units then have DC/DC converter to convert (in their example) the +48V to “+3.3V, +5V, +12V, etc.” Rather than supplying the individual voltages needed, they supplied +48V., which then had to be converted to the other voltages on each unit. These patents also describe in much detail, with many claims, the individual cabinets, that contain all of the function in one cabinet. I wish to take this to the next step and provide support facilities for all of the individual electronic units in the computer room or area, rather than building self contained sub-units, with DC/DC conversion. My patent is more restrictive, in that it refers only to the AC/DC power converters, but is broader in the sense that it extends the aggregation of AC/DC power converters to the whole area, rather than aggregating individual complete sub-units with separate redundancies, backups and controls. This extension of the art is important. We will be able to wire entire building or entire campuses with DC power, from the AC/DC converters not just sub-units. Further it should be possible to have only one voltage or at most two, and no DC/DC converters. Of course, DC power distribution is not a new idea. The original power distribution at the turn of the century was DC. But we are not really distributing power, but specific DC voltage power for operation of specialized equipment, This may seem like an obvious extension of the art, but the fact that in the last thirty years no one has done it, argues that it was not as obvious as it may seem.

Motherboards usually function well on low DC voltages but often Hard drives and other mechanical part function better with higher voltages, One may eventually have two standard DC voltages.

### BRIEF SUMMARY OF THE INVENTION

This invention is the next step in providing support facilities for all of the individual electronic units in a computer room or area. This patent is more restrictive than the MCI patents referred to above in that it refers only to AC/DC power converters, but it is broader in the sense that it extends the aggregation of AC/DC converters to the whole area, rather than aggregating individual complete sub-units with separate redundancies, backups and controls. Further it eliminates the DC/DC converters entirely. This invention is an extension of the idea of aggregating as many of the support facilities as possible in the whole area of the electronic equipment room.

### DETAILED DESCRIPTION OF THE INVENTION

My invention is a system to provide all of the power requirement for a group of different electronic devises from a centralized system. Thus you need no individual power supplies or converters on any of the individual electronic units. It is all about lowering the cost of operations by eliminating redundancy, and centralizing certain parts of the operation.

My Invention Has Three Parts:

1 The central AC/DC power converters. This will provide to each of the units the DC power required by that unit. If all of the units are near-identical they will have the same DC power supply requirements. It is desirable to have only one or at most two DC voltages as it simplifies the wiring to the individual unit. These voltages may be supplied by female mounted connector on the back plane that mesh with male connectors on the individual unit that are connected when the unit is pushed into place, and disconnects when the unit is pulled out. It is desirable to have two interconnected, independent power supplies either of which can carry the whole load, with controls and backup.

2 The connections with the individual units. These could be cables, but the best embodiment is as in 1. Above, where they connect with male-female connectors on the unit and the backplane.

3 The individual units. The individual units preferably plug into the female backplane that provides the correct voltages. The connector should be self-cleaning because low voltage connectors can give poor connections at the surfaces if not cleaned. In one embodiment there will be a fan and the DC connections that mate with the backplane. Another embodiment will be where the cooling air is supplied by a central cooling unit, and the fan will be replaced by a central cooling supply. Again it is about simplifying, increasing reliability, and decreasing costs

Another embodiment would be for offices, factories and other places that use multiple electronic equipment. There too, one would have one or more AC/DC converters, centrally located, with wiring throughout the building, or group of buildings of the necessary DC voltages. The individual units would be designed without AC power (such as lap top computers). With standardization of DC voltages, one would expect in the future buildings would be designed with AC/DC power conversion in mind. It is not likely that the whole building would go DC. That is very expensive for transmission between building, and all of the non-electronic requirements, but AC and DC would coexist, each doing what it does best. The DC would replace all unit power supplies, while the AC would run all of the other equipment (air conditioners for the room, lights etc.)

I claim:

1. A room or an area of the room or an entire building or group of buildings which,
a. has one or more independent but interconnected AC/DC power converters, and if there are two will be physically separated as much as possible, each capable of carrying the entire DC load, with proper controls and backup, and
b. the central unit will have connectors to each individual unit preferably,
c. by female connectors on the backplane for the proper voltages that connect when the individual electronic unit is pushed into place and,

2. the individual units will be modified for the DC power and connections, and the connections are in the region of the deleted AC/DC converter, and
a. in the embodiment where there is a centralized air supply and no voltages are need for a fan, less DC power is required, and

3 An embodiment where the whole building, or group of buildings is wired from the AC/DC converter, and has both AC for general use power, lights etc. and preferably only DC for electronic equipment, thus being more efficient and effective.
